(19) United States
(12) Patent Application Publication
(10) Pub. No.: US 2015/0233526 A1
(43) Pub. Date: Aug. 20, 2015

(54) EVACUATOR FOR REMOVAL OF NON-GASEOUS MATERIAL FROM GAS OUTLET EQUIPMENT

(71) Applicant: CHEMICAL INJECTION TECHNOLOGIES, INC., Fort Pierce, FL (US)

(72) Inventor: Howard Specker, Port Saint Lucie, FL (US)

(73) Assignee: CHEMICAL INJECTION TECHNOLOGIES, INC., Fort Pierce, FL (US)

(21) Appl. No.: 14/184,387

(22) Filed: Feb. 19, 2014

(51) Int. Cl. F17C 1/00; F17C 11/00

(52) U.S. Cl. CPC F17C 1/00; F17C 11/00

(57) ABSTRACT

Systems and methods for evacuating one or more volumes of a containment system of all non-gaseous materials. The systems and methods allow for a material to be outputted from a containment vessel in a substantially gaseous state. In particular, a discrete mass of a substantially inert gas may be utilized to evacuate one or more volumes of a containment system of all non-gaseous materials using a substantially inert gas, and such that once the evacuation process is initiated, it runs to completion without additional inputs from a user, and without the use of sensors and/or electronic components.

### BACKGROUND

Many industrial and domestic processes utilize gaseous materials. In some instances, these gaseous materials are stored, partially or wholly, in a liquid state at elevated pressures, e.g. at pressures above a vapor pressure for a given ambient temperature of the specific material. Chlorine (otherwise referred to as diatomic chlorine or molecular chlorine) is a common example of a material utilized in gaseous form, and stored at elevated or higher pressures, thereby resulting in a mass of liquid chlorine being stored in the containment vessel. For example, chlorine may be utilized in the disinfection of water for various agricultural processes. In another example, propane or butane may be used in a domestic setting for home heating and/or as a refrigerant. In such instances, when used as a fuel for heating appliances, the propane or butane may be referred to as liquefied petroleum gas, and stored in a pressurized containment vessel such that part or all of the mass of propane or butane is in a liquid state.

While materials may be stored at pressures above ambient atmospheric pressure, thereby liquefying part, or all, of the mass of the material in the pressurized containment vessel, it may be desirable to ensure that all of the material being outputted from the containment vessel has vaporized (all of the material outputted from the content vessel has changed to a gaseous state). For example, one or more pieces of equipment configured to process and/or utilize material stored in the pressurized containment vessel may be damaged if a mass of liquid and/or solid material is entrained within the gaseous output material. This is especially true for chlorine, which is very acidic and corrosive. Those of ordinary skill in the art will recognize that various devices exist for vaporizing materials that are outputted from a containment vessel in a liquid and/or solid-state. For example, heated liquid traps may be utilized along an output conduit from a containment vessel, wherein a heated liquid trap may be utilized to capture, and subsequently vaporize, any liquid outputted from the containment vessel, thereby preventing the liquid material from damaging equipment down-stream of the liquid trap. However, for a system operating at high material flow rates (high flow rate of material out of a pressurized containment vessel), some mass of liquefied material may still bypass liquid traps.

In addition to these masses of liquefied material, solidified impurities in an outpost material may give rise to further damage of down-stream processing equipment. As will be readily understood by those of ordinary skill in the art, molecular chlorine, having high reactivity, may give rise to chloride impurities within a containment vessel. In one specific example, iron (III) chloride, otherwise referred to as ferric chloride, may be present in a chlorine containment vessel. As such, solid impurities within a material stored in the containment vessel, and in particular, chloride impurities stored in a chlorine containment vessel, may cause damage to down-stream processing equipment is carried out of the containment vessel with gaseous chlorine.

### BRIEF SUMMARY

One or more of the above-mentioned needs in the art are satisfied by aspects described herein. According to one aspect, a device may include a base structure having an inert gas coupling for receiving a discrete mass of inert gas (e.g., nitrogen gas in some implementations), and a containment vessel coupling, for removably coupling the device (which may be a unitary device) to a containment vessel, which contains at least one gaseous material and/or liquid material. In one embodiment, at least one of the materials may comprise molecular chlorine. The device may be removably coupled through a connecting tube. The inert gas coupling may be connected to the containment vessel coupling through an internal conduit within the base structure, and such that the discrete mass of nitrogen gas may be transmitted therebetween. In certain embodiments, a single actuation of a mechanical interface may result in the discrete mass of nitrogen gas being transmitted from the inert gas coupling through to the containment vessel, such that an entirety of a volume of the connecting tube and an eductor tube are evacuated of all non-gaseous materials. Furthermore, addition of the nitrogen gas to the containment vessel decreases the density and/or the percentage of volume of one or more materials within the vessel by less than 0.01%. In one embodiment, the actuation of the device is configured to decrease the molecular chlorine within the containment vessel by less than 0.01%. In another embodiment, the addition of inert gas to the containment vessel is configured to decrease the percentage of the molecular chlorine making up the total volume of the containment vessel by less than 0.01%.

In another aspect, a device may include a base structure having a gas coupling configured to receive the discrete mass of a gaseous material, and an inlet adapter and mechanical fastener configured to receive and fasten a connecting tube to the device, wherein the connecting tube connects the device to a containment vessel. The containment vessel may have two eductor tubes, including a first eductor tube within a mass of gaseous molecular chlorine, and a second eductor tube within a mass of liquid molecular chlorine. A single actuation of an interface may transmit the discrete mass of gaseous material from the gas coupling to the containment vessel, wherein transmission of the discrete mass of gaseous material evacuates a whole volume of the connecting tube and the first eductor tube of all non-gaseous materials. Further, the discrete mass of gaseous material is less than 0.01% of the total mass of molecular chlorine within the containment vessel.

In yet another aspect, a method may include removably coupling, using an eductor tube, and evacuated device to a pressurized vessel containing the first pressurized material, and removing all non-gaseous materials from the eductor tube by transmitting a discrete mass of a second pressurized material through the eductor tube into the pressurized vessel. The transmission of the second pressurized material may result from a single actuation of a mechanical interface.

This Summary is provided to introduce a selection of concepts in a simplified form that are further described below in the Detailed Description. The Summary is not intended to identify key features or essential features of the claimed subject matter, nor is it intended to be used to limit the scope of the claimed subject matter.

### BRIEF DESCRIPTION OF THE DRAWINGS

The present invention is illustrated by way of example and not limited in the accompanying figures in which like reference numerals indicate similar elements and in which:

FIG. 1 schematically depicts a material containment system according to one example embodiment;

FIG. 2 schematically depicts an evacuated device in accordance with one example implementation; and

FIG. 3 schematically depicts a flowchart diagram of an evacuation process in accordance with one example embodiment.

Further, it is to be understood that the drawings may represent the scale of different component of one single embodiment; however, the disclosed embodiments are not limited to that particular scale.

### DETAILED DESCRIPTION

Aspects of this disclosure relate to systems and methods for evacuating non-gaseous materials from one or more volumes of a containment system that includes a containment vessel. Accordingly, the systems and methods described in this disclosure allow for an improved removal process that ensures subsequent material(s) to be outputted from the containment vessel, at least for a fixed number of iterations (e.g., 1+) or quantity of time, are in a substantially gaseous state. In particular, the systems and methods described herein may be utilized to evacuate one or more volumes of a containment system of non-gaseous materials using an inert gas (with respect to the material being evacuated from the containment system). In accordance to one embodiment, once the evacuation process is initiated, it runs to completion without additional inputs from a user. In certain embodiments, the evacuation process, which may run to completion without additional inputs or actions from a user, is conducted entirely without the use of sensors and/or electronic components.

In the following description of the various embodiments, reference is made to the accompanying drawings, which form a part hereof, and in which is shown by way of illustration various embodiments in which aspects of the disclosure may be practiced. It is to be understood that other embodiments may be utilized and structural and functional modifications may be made without departing from the scope and spirit of the present disclosure.

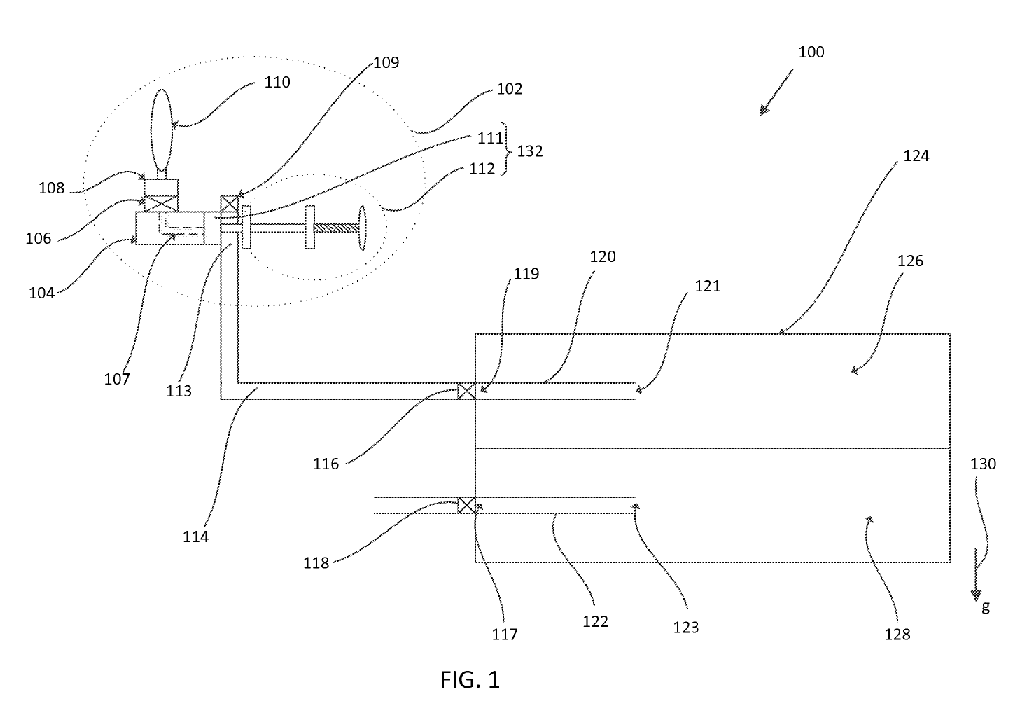

Certain implementations are performed with a single device that may be connected to (e.g., removably) and/or part of a material containment system. FIG. 1 schematically depicts an example material containment system 100. In particular, system 100 may be utilized for storage of one or more materials at pressures above ambient atmospheric pressure. In one embodiment, containment vessel 124 may be used to store a gaseous material, a liquid material, a solid material, or combinations thereof. As such, containment vessel 124 may be constructed from a material capable of containing a gas, a liquid, a solid, or combinations thereof, at a pressure substantially equal to, above or below ambient atmospheric pressure. In one example, containment vessel 124 may be constructed from a metal, an alloy, a polymer, a fiber-reinforced material, a ceramic, or any other synthetic or natural material, or combinations thereof, capable of structurally containing a gas, a liquid, a solid, or combinations thereof. In one specific example, containment vessel 124 may be constructed, partially or wholly, from stainless steel, or a chromium-plated alloy, thereby allowing the containment vessel 124 to resist corrosion by one or more materials contained within. In one specific example, storage of a chlorine material, or a mixture of chlorine and water, may use a metal, an alloy, a ceramic, or a polymer storage container (storage tank/cylinder/“ton container”), and wherein the storage container, in one example, may not be stainless steel. Those of ordinary skill in the art will readily recognize various other structural materials and/or coatings configured to resist corrosion of various kinds, wherein these additional or alternative materials and coatings do not depart from the scope of the disclosure described herein.

Containment system 100 may further include (or be configured to removably receive) an evacuator device, such as evacuator device 102). Evacuator device 102 may be configured as a single device that is configured to evacuate a portion of containment system 100 without adverse effects on the remaining portions of system 100. The example evacuator device 102 shown in FIG. 1 comprises a base structure 104 having a cartridge inlet valve 106 connected to an internal conduit 107, and an inert gas coupling 108 that may be configured to receive inert gas at a pressure that is higher than ambient pressure. In one embodiment, inert gas coupling may be configured to receive a cartridge, such as cartridge 110. Cartridge 110 may contain a predefined or known amount of inert gas. In other embodiments, inert gas coupling 108 may be configured to be attached to a feed line that supplies the inert gas(es). The feed line may be configured to provide an inert gas at a known rate or provide a predetermined amount, such as for example via the use of a solenoid valve or other mechanism(s).

Evacuator device 102 may further be configured such that internal conduit operatively connects, and thus allows the passage of pressured gas between, the cartridge valve inlet 106 and a containment vessel coupling, such as coupling 132. Looking to the example containment vessel coupling 132, it comprises an inlet adapter 111 and a fastener, shown as mechanical fastener 112. Mechanical fastener 112 is shown is being configured to permit the operative securement of evacuator device 102 with the first end 113 of connecting hose 114. Connecting hose 114 may be part of the device, such as a threaded hose that may adapt the evacuator device 102 to one of a plurality of different containment vessels 124. In yet another embodiment, at least a portion of hose 114 may be part of the containment vessel 124, such that evacuator device 102 can directly attach to it. Regardless, connecting hose/tube 114 may comprise a hose valve 109, which is explained in more detail below.

FIG. 1 further shows an example containment vessel that may be used in accordance with certain implementations. As discussed above, fastener 112 is shown is being configured to permit the operative securement of evacuator device 102 with the first end 113 of connecting hose 114. Connecting hose 114 may include another valve on the end opposite the hose valve 109. In yet other embodiments, containment vessel 124 has a first valve 116 configured to operatively connect connecting hose 114 to a first eductor tube 120. The first valve 116/eductor tube 120 may be one of a plurality of egress points of the containment system 100. For example, a second valve 118 is shown as being connected to a second eductor tube 122. Additionally, as depicted in the exemplary embodiment of FIG. 1, containment vessel 124 contains a mass of gaseous material 126, and a mass of liquid material 128. In one example implementation, the gaseous material 126 may be gaseous chlorine and the mass of liquid material 128 may be liquid chlorine.

Those of ordinary skill in the art will recognize that the constituent components depicted in FIG. 1 may comprise a variety of materials, without departing from the scope of this disclosure. As already indicated, containment vessel 124 may be constructed from, among others, metals, alloys, polymers, ceramics, fiber-reinforced materials, or other synthetic or natural materials, or combinations thereof. Similarly, eductor tubes 120 and 122 may comprise one or more materials such that the eductor tubes 120 and 122 may be rigid, or flexible. Accordingly, eductor tubes 120 and 122 may comprise one or more of a metal, an alloy, a polymer, or another synthetic or natural material, or combinations thereof. In one embodiment, the first eductor tube 120 may be referred to as an “upper” eductor tube, and the second eductor tube 122 may be referred to as an “lower” eductor tube. However, these descriptions should not limit this disclose to any specific orientation of the depicted components.

Eductor tubes 120 and 122 may have a longitudinal length. For example, the longitudinal length of eductor tubes 120 and 122 may measure less than 5 cm, between 5 cm and 30 cm, or greater than 30 cm, among others. Indeed, these are merely example lengths. In one implementation, a length of the first eductor tube 120 may be different to a length of the second eductor tube 122.

In one implementation, the first eductor tube 120 may be coupled to a first opening in containment vessel 124 at the first valve 116. Similarly, the second eductor to 122 may be coupled to a second opening in containment vessel 124 at the second valve 118. Furthermore, valves 116 and 118 may comprise any valve type known to those of ordinary skill in the art, and such that valves 116 and 118 are constructed to seal containment vessel 124 from input/output of gaseous, liquid, and/or solid materials upon closure of the valves 116 and/or 118. Furthermore, the disclosures described herein may be utilized with a single opening in containment vessel 124, such as that opening associated with valve 116, or with more than the two openings depicted as associated with valves 116 and 118. Additionally, as will be readily apparent to those of ordinary skill the art, valves 116 and/or 118 may be designed to withstand pressure levels above ambient atmospheric pressure as a result of increased/decreased (vacuum) internal pressure within containment vessel 124.

In one example, containment vessel 124 is configured to contain a mass of a material, or mixture of materials, at elevated or high internal pressure. Accordingly, in one example, part, or all, of a material stored in containment vessel 124 may be in a liquid state due to an internal pressure level within containment vessel 124 being above a vapor pressure level for the stored material at the temperature within containment vessel 124. In one example, a material stored in containment vessel 124 may have a mass of liquid 128 and a mass of gas 126, wherein the liquid 128 and gas 126 are separated, as depicted in FIG. 1, based upon differences in density. Accordingly, the mass of liquid 128 may be positioned at a lower level than the mass of gas 126 due to the gravitational force indicated by arrow 130. In one specific example, containment vessel 124 may store a mass of chlorine material, wherein said chlorine material may otherwise be referred to as diatomic chlorine, or molecular chlorine. Accordingly, when pressurized to an internal pressure level above a vapor pressure level for a given ambient temperature within containment vessel 124, part of the mass of chlorine material may be in a liquid state 128, and part of the chlorine material may be in a gaseous state 126. For example, at a temperature of 300 K, chlorine has a vapor pressure of approximately 8 bar (0.8 MPa). As such, storage of chlorine in containment vessel 124 with an internal pressure of 0.8 MPa at a temperature of 300 K will result in a mass of liquid chlorine 128 in addition to the mass of gaseous chlorine 126. In one example, the physical location of containment vessel 124 within an industrial environment (e.g. a factory, processing plant etc.) may result in significant temperature variation of the material stored therein (e.g. temperature variation of 60 K or more if containment vessel 124 is stored outdoors). For example, if stored outside in an area exposed to direct sunlight during daylight hours, the vessel 124 may be exposed to significant temperature fluctuations. Furthermore, a pressure level within containment vessel 124 will vary based upon a temperature of the material stored therein.

Those of ordinary skill in the art will recognize that containment vessel 124 may be utilized to store a variety of different materials in additionally or alternatively to chlorine. For example, containment vessel 124 may be utilized to store ammonia, propane, butane, among many others. Furthermore, containment vessel 124 may be utilized to store a mixture of different materials. In one implementation, containment vessel 124 may have a single internal cavity and may have at least two openings for facilitating input and output of a material containment therein. In one example, the at least two openings may correspond to the first valve 116 and the second valve 118. Furthermore, an internal volume of containment vessel 124 may be any volume ranging from 1 L or less to 500 L or more. In one specific example, containment vessel 124 may be referred to as a “ton container,” wherein a ton container is known to those of ordinary skill in the art and may have an internal volume of approximately 416 L. Furthermore, containment vessel 124 may have a pressure rating of 140 bar or more. In one implementation, containment vessel 124 may have a substantially cylindrical shape, however those of ordinary skill in the art will appreciate that containment vessel 124 may have any shape, such as, among others, a cubic shape, a cuboidal shape, or a spherical shape, and the like.

In one implementation, a first end 119 of the first eductor tube 120 may be coupled to an inner side of a first opening in containment vessel 124, and at the first valve 116. Similarly, a first end 117 of the second eductor tube 122 may be coupled to a second opening in the containment vessel 124 at valve 118. Accordingly, a second end 121 of the first eductor tube 120 may be open to the internal volume of containment vessel 124. As such, the second end 121 of the first eductor tube 120 may be open to the pressurized mass of gas 126 within containment vessel 124. Similarly, a second end 123 of the second eductor tube 122 may be open to the pressurized mass of liquid 128 within containment vessel 124.

In one example, one or more of valves 116 and/or 118 comprise a pressure regulator device configured to reduce a pressure level of a material being outputted from containment vessel 124. Those of ordinary skill in the art will recognize various pressure regulator designs and/or configurations that may be used in the system 100 depicted in FIG. 1, without departing from this disclosure.

In one implementation, containment vessel 124 is connected to evacuator device 102 by connecting hose 114. As will be readily apparent to those of ordinary skill in the art, connecting hose 114 may comprise any suitable hose and/or tubing configuration suitable for conveying the material (or mixture of materials) stored in containment vessel 124, taking into consideration the pressure, temperature, and reactivity (corrosiveness), among others, of the material stored within containment vessel 124.

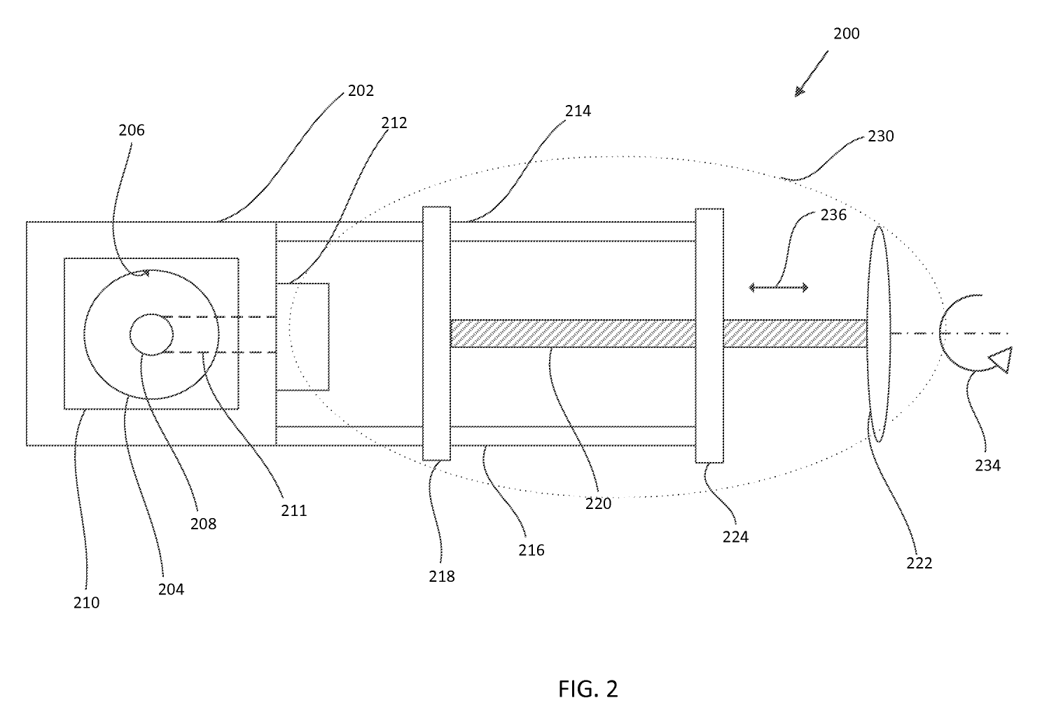

In one implementation, mechanical fastener 112 may be configured to removably couple a first end 113 of connecting hose 114 to evacuator device 102 at inlet adapter 111. As such, mechanical fastener 112 may comprise one or more different mechanical fastening means including, but not limited to, a screw-drive clamp fastener, a threaded coupling, a fastener secured by one or more threaded nuts and/or bolts, one or more bayonet socket fasteners, rivet fasteners, pinned fasteners, or any other suitable fastening means known to those of ordinary skill in the art. In one implementation, mechanical fastener 112 may comprise a manually-actuated interface. Accordingly, in one implementation, the mechanical fastener 112 is configured as a manually-actuated screw drive, as described in further detail in relation to FIG. 2. In other implementations, however, mechanical fastener 112 may comprise one or more electromechanical elements to removably couple the first end 113 of connecting hose 114 to evacuator device 102.

In one configuration, the first end 113 of connecting hose 114 may terminate at hose valve 109, wherein hose valve 109 may comprise any valve type known to those of ordinary skill in the art. As such, hose valve 109 may be configured to be manually-actuated (opened/closed) using a wrench tool, among others. In another configuration, evacuator device 102 may be directly coupled to containment vessel 124 such that connecting hose 114 is not utilized. In such instances, evacuator device 102 may be directly coupled to valve 116, and hose valve 109 may not be utilized, and the like.

In one example, evacuator device 102 is configured to receive cartridge 110, wherein cartridge 110 comprises a pressure vessel configured to store a mass of an inert gas. In one example, cartridge 110 may be configured to store a mass of nitrogen gas, however those of ordinary skill in the art will readily understand that the various other inert, or substantially unreactive gases may be utilized, without departing from the scope of this disclosure. For example, cartridge 110 may be configured to store one or more noble gases, and the like. In another example, cartridge 110 may be configured to store pressurized air (a mixture of nitrogen and oxygen, among others), or pressurized carbon dioxide, among others. Accordingly, cartridge 110 may comprise any suitable material with material characteristics for withstanding high pressure and/or temperature. In one example, cartridge 110 may have an internal volume of 95 cm³. In another example, cartridge 110 may have an internal volume of less than 100 cm³. In one example, cartridge 110 may store less than 20 g of nitrogen gas. In another example, cartridge 110 may store approximately 18 g of nitrogen gas. In yet another example, as will be apparent to those of ordinary skill in the art, any size of cartridge 110 and any mass of inert gas, such as nitrogen gas, may be utilized with the disclosure described herein, and such that the mass of inert gas will be configured based on a volume of one or more of the connecting hose 114 and/or the eductor tube 120, among others. In one example, cartridge 110 may be pressurized to a pressure greater than 6 MPa.

In one example, cartridge 110 comprises a threaded end (not shown) configured to be received into a threaded sidewall (see, for example, threaded sidewall 205 from FIG. 2) of the inert gas coupling 108. Those of ordinary skill in the art will readily understand that any size of screw threads may be utilized without departing from the spirit of this disclosure. Cartridge 110 may be configured with an outlet (not shown) from which the stored material within cartridge 110 is ejected. In one implementation, the opening in cartridge 110 (not shown) is sealed with a sacrificial area of material that is configured to be punctured by a puncture assembly (see, for example, puncture assembly 208 from FIG. 2). In another example, the opening in cartridge 110 (not shown) is sealed by an apparatus configured to be resealable, and the like. In this example, the resealable opening in cartridge 110 may be actuated by the inert gas coupling 108.

In one implementation, evacuator device 102 comprises a cartridge inlet valve 106, wherein cartridge inlet valve 106 is configured to allow gas to pass from cartridge 110 into base structure 104. Accordingly, cartridge inlet valve 106 may comprise any suitable valve known to those of ordinary skill in the art. As such, cartridge inlet valve 106 may have an interface configured to be actuated (opened and closed) by a user (i.e. manually) and/or by an external tool (mechanical or electromechanical tool). For example, cartridge inlet valve 106 may comprise a nut configured to be loosened and tightened to open and close the valve, respectively. In another example, cartridge inlet valve 106 may be a one-way valve such that the valve does not have an interface configured to be opened and closed by external means.

In one implementation, base structure 104 comprises one or more internal conduits (tubes and/or channels) 107 configured to convey a gaseous material from cartridge 110 through to inlet adapter 111. As such, in one example, inlet adapter 111 comprises a socket and/or interface for cooperatively coupling to one or more of the first end 113 of connecting hose 114, or directly to containment vessel 124. Accordingly, inlet adapter 111 may comprise any known interface for coupling to a hose and/or tubing known to those of ordinary skill in the art.

In one example, one or more masses of liquid and/or solid materials may collect within the first eductor tube 120 and/or the connecting hose 114. For example, part of the mass of liquid 128 (which may come in one example, and be liquid chlorine), may collect in eductor tube 120 and/or the connecting tube 114. Those of ordinary skill in the art will understand various scenarios that may result in a non-gaseous materials being collected in the first eductor tube 120 and/or the connecting tube 114, which may include, among others, the containment vessel 124 being moved, resulting in perturbation of the material (mass of gas 120 and/or mass of liquid 128) contained therein.

In one example, in addition to the mass of gas 126 and the mass of liquid 128, containment vessel 124 may store an amount of impurities. For example, in the case of the mass of gas 126 and the mass of liquid 128 being substantially molecular chlorine, chloride compound impurities may be formed and entrained within containment vessel 124 due to chemical reactivity of chlorine. In one specific example, iron (III) chloride, otherwise referred to as ferric chloride, maybe one such example of a chloride compound impurity. As such, containment vessel 124 may contain one or more impurities in solid and/or liquid states. Accordingly, additionally or alternatively, one or more impurities may be present in the first eductor tube 120 and/or the connecting hose 114.

Those of ordinary skill in the art will understand that it may be desirable to reduce the amount of liquid and/or solid impurities present within the first inductor to 120 and/or the connecting hose 114 prior to containment vessel 124 being connected to down-stream processing equipment (not shown). Advantageously, evacuator device 102 may be utilized to clear (evacuate) a whole volume of one or more of the connecting hose 114 and/or the first eductor tube 120 of all non-gaseous materials by flowing an inert gas (in one example, nitrogen) from cartridge 110 through cartridge inlet valve 106, internal conduits 107 of base structure 104, inlet adapter 111, optional hose valve 109 (which may be selectively placed in either an open or a close state), and through to connecting hose 114 and the first eductor tube 120. Further advantageously, evacuator device 102 may be configured such that a discrete (known) mass of inert gas is utilized to evacuate one or more of the connecting hose 114 and/or the first eductor tube 120 such that the materials (mass of gas 126 and mass of liquid 128) are not significantly contaminated/diluted/changed by the addition of the discrete mass of gas from cartridge 110. In one example, the mass of gas from cartridge 110 transmitted into containment vessel 124 is less than 0.01% of the mass of materials within containment vessel 124 prior to transmission of the mass of gas from cartridge 110. In another example, the mass of gas from cartridge 110 is less than 0.001% of the mass of the materials within containment vessel 124 prior to transmission of the mass of gas from cartridge 110.

FIG. 2 schematically depicts an evacuator device 200. In one example, evacuator device 200 may be similar to evacuator device 102 from FIG. 1. Specifically, evacuator device 200 includes a base structure 202, and an inert gas coupling 204 having threaded sidewalls 206 and puncture assembly 208, a cartridge inlet valve 210, and inlet adapter 212, internal conduits 211, and a mechanical fastener 230 further comprising guide rails 214 and 216, slide bar 218, screw drive 220, handle 222, and end stop 224.

Inert gas coupling 204 of evacuator device 200 may be similar to inert gas coupling 108 from FIG. 1. As such, inert gas coupling 204 may be configured to receive a discrete mass of an inert (in one example nitrogen) gas from a container, which may be a cartridge. However, those of ordinary skill in the art will understand that the term cartridge may refer to any containment vessel known in the art that is capable of holding a discrete mass of inert gas at high pressure. In one specific embodiment, inert gas coupling 204 comprises threaded sidewalls 206 such that a threaded interface (gas inlet/outlet) of a gas cartridge may be releasably coupled to said threaded sidewalls 206. Those of ordinary skill in the art will appreciate that a cartridge (such as cartridge 110 from FIG. 1) may be releasably coupled to the inert gas coupling 204 by any coupling means, including, among others, screw threads, a bayonet coupling, clips, an interference fit, or a mechanical clamp, among many others.

Puncture assembly 208 of inert gas coupling 204 may be utilized to pierce a hole in a gas cartridge, such as gas cartridge 110 from FIG. 1. Accordingly, puncture assembly 208 may comprise a hollow shaft with a sharp endpoint (not shown), which may be similar to a hollow needle. In another example, puncture assembly 208 may comprise a mechanism for opening a resealable outlet of a gas cartridge, such as cartridge 110 from FIG. 1, wherein in this instance, puncture assembly 208 comprises a blunt pin, among others.

In one implementation, inert gas coupling 204 may be connected to the inlet adapter 212 by internal conduit 211, such that a gas may be transmitted from a cartridge, such as cartridge 110 from FIG. 1, through to inlet adapter 212. Accordingly, inlet adapter 212 may be configured to connect directly, or via a connecting hose (not shown), to a containment vessel, such as containment vessel 124 from FIG. 1.

The displayed mechanical fastener, (mechanical fastener 230) is one of a plurality of different fastening means for removably coupling a device to evacuator device 200. Any device that can secure evacuator device, such as device 200 to transfer pressurized gas to a vessel falls within the scope of this disclosure. In one specific example, mechanical fastener 230 is utilized to removably couple a connecting hose, such as, for example, connecting hose 140 from FIG. 1, to inlet adapter 212. Accordingly, mechanical fastener 230 comprises guide rails 214 and 216, slide bar 218, screw drive 220, handle 222, and end stop 224. In one embodiment, slide bar 218 is configured to move in a linear direction along guide rails 214 and 216 towards inlet adapter 212, and actuated by screw drive 220, which is coupled to end stop 224 by screw threads. Upon actuation of handle 222, wherein actuation may be manual rotation of handle 222 about an axis in the direction indicated as rotation direction 234, threads on screw drive 220 engage with corresponding threads on end stop 224 to drive slide bar 218 in a linear direction indicated by direction arrow 236. Accordingly, handle 222 may be actuated such that slide bar 218 contacts an end of a connecting hose, such as connecting hose 114 from FIG. 1, to maintain a sealed connection between said connecting hose and the inlet adapter 212.

Advantageously, evacuator device 200 may be utilized to evacuate the non-gaseous materials from one or more of a connecting tube and an eductor tube associated with a containment vessel (such as, for example, connecting hose 114 and eductor tube 120 of containment vessel 124 from FIG. 1). In one embodiment, over 99% of the non-gaseous materials are removed. In one embodiment, over 99.9% of the non-gaseous materials are removed. The evacuator devices disclosed herein, including device 200, may be utilized to evacuator/clear and entire volume of one or more of a connecting hose and/or an eductor tube using a discrete mass of an inert gas, such as nitrogen gas. In this way, by using a discrete predetermined mass of an inert gas, evacuator device 200 may not change the density more than 0.1% of at least one material stored in a containment vessel, such as containment vessel 124, by an appreciable amount. In one embodiment, a discrete mass of inert gas utilized by evacuator device 200 to evacuate an entire volume of one or more of a connecting hose and/or an eductor tube of all non-gaseous materials may increase the density of a material stored in a containment vessel, such as containment vessel 124, by less than 0.01%. In another example, a discrete mass of inert gas utilized by evacuator device 200 may evacuate an entire volume of one or more of a connecting tube and/or eductor tube with an increase in density of material stored in a containment vessel of less than 0.001%.

Further advantageously, evacuator device 200 may allow for evacuation of one or more of a connecting tube and/or an eductor tube as a result of a single actuation of a mechanical interface from a user and/or an electromechanical device (not shown). For example, evacuator device 200 may be utilized to clear an entire volume of one or more of a connecting tube and/or at an eductor tube using a discrete mass of inert gas as a result of a single actuation. In one embodiment, the device may be equipped with a cartridge, such as cartridge 110, into cartridge inlet valve 210. As such, the known (discrete) mass of inert (e.g., nitrogen) gas within cartridge 110 may be transmitted from cartridge inlet valve 210 through internal conduit 211 to inlet adapter 212, and through one or more of a connecting hose 114 and/or eductor tube 120 into a containment vessel 124. This transmission of the inert gas (which may be at or above a pressure threshold) may evacuate an entire volume of one or more of the connecting hose 114 and/or eductor tube 120 of all non-gaseous materials, without further actuation from a user and/or other actuation device. Furthermore, this evacuation process may be carried out without the use of feedback sensors, such as, among others, flow rate sensors and/or pressure sensors, among many others. In this regard, the disclosed devices may be devoid of any feedback sensors and/or allow for processes that do not employ feedback sensors.

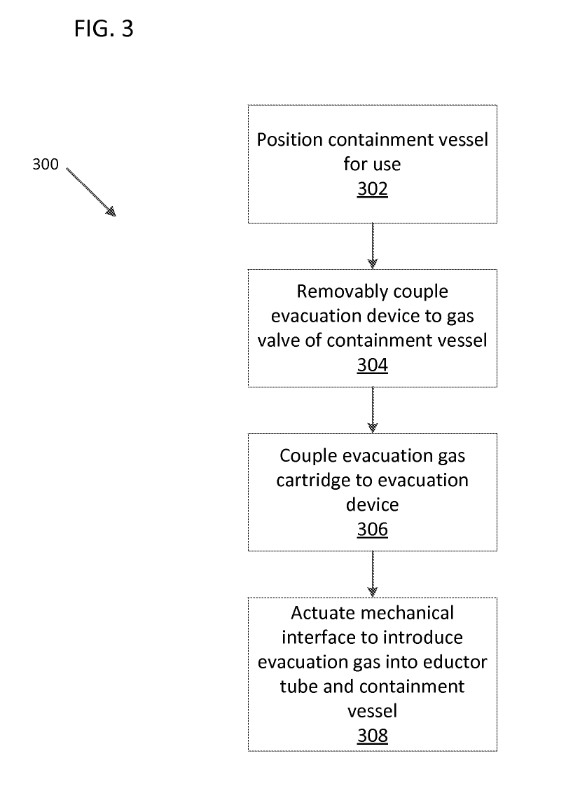

FIG. 3 schematically depicts a flowchart diagram of an evacuation process. In particular, flowchart 300 may be implemented to evacuate one or more volumes of a containment system, such as one or more volumes of a connecting hose 114 and/or an eductor tube 120 of containment system 100 from FIG. 1. One or more portions of flowchart 300 may be executed by one or more processors, wherein those of ordinary skill in the art will readily understand us a processor may be a dedicated one or more processing cores, or a general-purpose central processing unit. Accordingly, flowchart 300 may include one or more computer-implemented methods executed from instructions stored on one or more non-transitory computer-readable media. Additionally or alternatively, one or more portions of flowchart 300 may be executed manually by one or more human users, and without the use of electronic processing, sensors and/or automation devices.

In one example, flowchart 300 may include the utilization of a containment vessel, such as containment vessel 124 from FIG. 1, being positioned/re-positioned for use. In one example, this movement of the containment vessel may be associated with block 302 of flowchart 300. Accordingly, movement of the containment vessel, such as containment vessel 124, may result in one or more masses of liquid and/or solid being entrained within the first eductor tube 120 and/or connecting hose 114 as a result of turbulence/“splashing”within the volume of containment vessel 124. It will be readily apparent to those of ordinary skill in the art that one or more masses of liquid and/or solids within the first eductor tube 120 and/or connecting hose 114 may damage one or more processing devices down-stream from containment vessel 124 if said masses of liquid and/or solids are transmitted with a mass of gas, such as gas 126, from containment vessel 124.

In one example, an evacuation device, such as evacuation device 102, may be removably coupled to the containment vessel 124 to clear/evacuate an entire volume of one or more of connecting hose 114 and/or the first eductor tube 120 of all non-gaseous materials. Accordingly, in one implementation, the evacuator device 102 may be removably coupled to containment vessel 124 at block 304 of flowchart 300. Accordingly, one or more methods of removably coupling evacuator device 102 to containment vessel 124 will be clear from the foregoing disclosures.

A discrete mass of an inert gas (which may be at or above a pressure threshold), such as nitrogen gas, may be utilized to evacuate an entirety of one or more volumes of connecting hose 114 and/or the first eductor tube 120 of all non-gaseous materials. In one example, the discrete mass of nitrogen gas may be stored in a cartridge, such as cartridge 110. As such, in one example, cartridge 110 may be removably coupled to evacuator device 102. Accordingly, removably coupling of cartridge 110 to evacuator device 102 may be represented by block 306 of flowchart 300.

In one example, after the evacuator device is operatively secured to transmit inert gas into the vessel, a single actuation of a mechanical interface may be utilized to transmit a discrete mass of an inert gas into one or more volumes of connecting hose 114 and/or the first eductor tube 120 in order to entirely evacuate said connecting hose and/or eductor tube of all non-gaseous materials. As such, in one example, this single actuation of a mechanical interface may be associated with block 308 of flowchart 300. Furthermore, in one example, the single actuation may be inserting a gas cartridge, such as cartridge 110, into inert gas coupling 108 and puncture assembly 208, and the like. In yet another example, the single actuation may include opening a valve, such as hose valve 109, to allow the discrete mass of nitrogen gas to be transmitted from cartridge 110 through to connecting hose 114, as depicted FIG. 1.

We claim:

1. A unitary device comprising:
a base structure, comprising:
an inert gas coupling, configured to receive a discrete mass of nitrogen gas at a first pressure level;
a containment vessel coupling, configured to removably and cooperatively couple the device to an opening of a containment vessel via a connecting tube, wherein the containment vessel has a gaseous mass and a liquid mass of molecular chlorine contained therein at a second pressure level, the containment vessel further having an eductor tube within the containment vessel with a longitudinal length, a first end coupled to the opening, and a second end open to the gaseous mass and not to the liquid mass;
an internal conduit configured to transmit the received discrete mass of nitrogen gas between the inert gas coupling and the containment vessel coupling; and
a mechanical interface configured to be actuated between a first state and a second state, wherein upon a single actuation of the mechanical interface, the discrete mass of nitrogen gas is transmitted from the inert gas coupling through to the containment vessel, wherein transmission of the discrete mass of nitrogen gas evacuates an entirety of a volume of the connecting tube and the eductor tube of all non-gaseous materials, and wherein introduction of the nitrogen gas decreases a density of the liquid and the gaseous chlorine within the containment vessel by less than 0.01%.

2. The unitary device of claim 1, further comprising:
a cartridge configured to store the mass of nitrogen gas, wherein the cartridge has an internal volume of less than 100 cubic centimeters.

3. The unitary device of claim 1, wherein the first pressure level is higher than the second pressure level.

4. The unitary device of claim 2, wherein the cartridge is pressurized with a pressure of over 6 megapascals.

5. The unitary device of claim 1, further comprising:
a connecting hose valve, wherein the single actuation of the mechanical interface comprises actuating the connecting hose valve between a closed and an open state.

6. The unitary device of claim 1, wherein the single actuation of the mechanical interface comprises removably coupling a nitrogen gas cartridge to the inert gas coupling on the unitary device.

7. The unitary device of claim 6, wherein the inert gas coupling is further configured to puncture an opening in the nitrogen gas cartridge.

8. The unitary device of claim 6, wherein the single actuation of the mechanical interface further comprises screwing a threaded end of the nitrogen gas cartridge into a threaded sidewall of the cartridge inlet valve.

9. The unitary device of claim 6, wherein the inert gas coupling is positioned at an angle of 90 degrees relative to the containment vessel coupling.

10. The unitary device of claim 1, wherein the introduction of the nitrogen gas decreases a density of molecular chlorine within the containment vessel by less than 0.001%.

11. The unitary device of claim 1, wherein containment vessel further contains non-gaseous chloride compound impurities that are cleared from the volume of the connecting tube and eductor tube by the discrete mass of nitrogen gas received at the eductor tube.

12. The unitary device of claim 11, wherein the non-gaseous chloride compound impurities comprise iron (III) chloride.

13. A device, comprising:
a base structure, further comprising:
a gas coupling, configured to receive a discrete mass of a gaseous material at a first pressure level;
an inlet adapter, configured to receive a first end of a connecting tube, wherein a second end of the connecting tube is coupled to a first opening in a containment vessel, wherein the containment vessel has a gaseous mass and a liquid mass of molecular chlorine contained at a second pressure vessel, the containment vessel containing a first eductor tube having a first longitudinal length, a first end coupled to the first opening, and a second end open to the gaseous mass, and a second eductor tube having a second longitudinal length, a first end coupled to a second opening, and a second end open to the liquid mass;
a mechanical fastener, configured to removably fasten the first end of the connecting tube to the base structure;
an internal conduit, configured to transmit the discrete mass of gaseous material between the gas coupling and the inlet adapter;
a interface, wherein upon a single actuation of the interface, the discrete mass of gaseous material is transmitted from the gas coupling to the containment vessel, wherein transmission of the discrete mass of gaseous material evacuates a whole volume of the connecting tube and the first eductor tube of all non-gaseous materials, wherein the discrete mass of gaseous material introduced into the containment vessel is less than 0.01% of a total mass of molecular chlorine within the containment vessel.

14. The device of claim 13, wherein the interface comprises only mechanical components.

15. The device of claim 14, wherein the discrete mass of gaseous material is nitrogen gas.

16. The device of claim 13, wherein the single actuation of the interface comprises removably coupling the gas coupling to a cartridge containing the discrete mass of gaseous material.

17. The device of claim 13, wherein the first pressure level is greater than the second pressure level.

18. The device of claim 13, wherein the first pressure level is at least ten times greater than the second pressure level.

19. The device of claim 13, wherein evacuation of the whole volume of the connecting tube and the first eductor tube removes chloride compound impurities.

20. A method, comprising:
removably coupling, via an eductor tube, an evacuator device to a pressurized vessel containing a first pressurized material; and
evacuating non-gaseous materials from the eductor tube by flowing a discrete mass of a second pressurized material through the eductor tube into the pressurized vessel, wherein the second pressurized material is pressurized to a higher pressure level than the first pressurized material before evacuation, wherein evacuation occurs as a result of a single actuation of an interface, and wherein the interface comprises only mechanical components.
